(19) United States
(12) Patent Application Publication
(10) Pub. No.: US 2005/0162820 A1
(43) Pub. Date: Jul. 28, 2005

(54) Host structure for notebook computers

(76) Inventors: Beniz Wang, Taipei (TW); Paul Chang, Taipei (TW)

Correspondence Address: RABIN & BERDO, P.C., Suite 500, 1101 14 Street, N.W., Washington, DC, 20005, US

(21) Appl. No.: 10/762,486

(22) Filed: Jan. 23, 2004

(51) Int. Cl. G06F 1/16

(52) U.S. Cl. 361/683; 361/684; 361/685; 312/223.1; 312/223.2

(57) ABSTRACT

A host structure for notebook computers includes a bottom member and a top member. The bottom member houses electronic elements such as main board, connectors, battery and the like. The top member is coupled on the bottom member to form a notebook computer host. The bottom member is a standardized member. The top member may be redesigned according to requirements so that the bottom member may be coupled with the top member of different designs to form new notebook computer host models. Thereby vendor's development time for the new notebook computer models may be greatly shortened.

### FIELD OF THE INVENTION

The present invention relates to a host structure for portable electronic data processing apparatus and particularly for notebook computers.

### BACKGROUND OF THE INVENTION

Portable electronic data processing apparatus such as notebook computers have a lot of advantages, such as the possibility to carry anywhere and use anywhere anytime. They also become ever more powerful. In addition, with increasingly well-developed wireless network environments, it is likely that they will gradually replace the desktop computers.

The notebook computer generally consists of a host and a display device. The display device is pivotally coupled on one side of the host in a turning manner so that it can be lifted relative to the host or be folded over the host. The technology for notebook computers is well developed at present. The host mainly includes electronic elements such as a main board, central processor, memory, various connectors, hard disk drive, optical disk drive, radiation fan, battery, etc. These electronic elements almost become standard elements now. Aside from boosting their performances (such as the central processor), their assembly relationship does not change very much. However, notebook computer vendors still have to develop and introduce new models constantly to meet customers' requirements. These days most notebook computer vendors develop new types of notebook computers from a industrial design perspective that heavily focuses on style. When a new type of notebook computer has been designed by the industrial design department of the vendors, it cannot be fabricated and produced immediately. The industrial design department has to coordinate with the electronic research and development department to adjust the locations of all related electronic elements. When the electronic research and development department thinks the new style cannot accommodate all the required electronic elements, the new style will be vetoed, and the industrial design department has to redesign. Hence developing a new notebook computer model often involves a lot of coordination and communication between the related departments before production begins. It is a lengthy and time-consuming process.

Moreover, when the notebook computer vendor introduces a new model, almost everything has to be designed anew. The notebook computer vendor has to prepare required electronic elements. This creates a great deal of inventory pressure for the vendor.

### SUMMARY OF THE INVENTION

In view of the problems of lengthy development cycles and high inventory costs involved in introducing new models of conventional notebook computers, the invention aims to provide a modular notebook computer host structure.

The host structure for notebook computers according to the invention includes a bottom member and a top member. The bottom member is for housing electronic elements such as a main board, central processor, memory, various connectors, hard disk drive, an optical disk drive, a radiation fan, battery, etc. The bottom member is a standardized member. The top member can be redesigned according to requirements and coupled on the bottom member. Therefore, the bottom member can be coupled with the top member of different designs to form a new type of notebook computer.

For the general notebook computer, the style mainly focuses on the topside of the host and the display device. According to the host structure of the invention, the bottom member is a standardized member. Hence notebook computer vendors have to design only the top member to obtain a new model and style. The industrial design function no longer has to coordinate with the electronic research and development function. Development time needed for new machine types can be greatly shortened. As the bottom member is standardized, inventory costs can also be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a schematic view of the invention after being assembled.

FIG. 3 is a schematic view of the top member of the invention.

### DESCRIPTION OF THE PREFERRED EMBODIMENT

The host structure for notebook computers according to the invention mainly aims at the host of portable electronic apparatus. The general notebook computer includes a host and a display device. The present invention mainly focuses on improvement of the host portion.

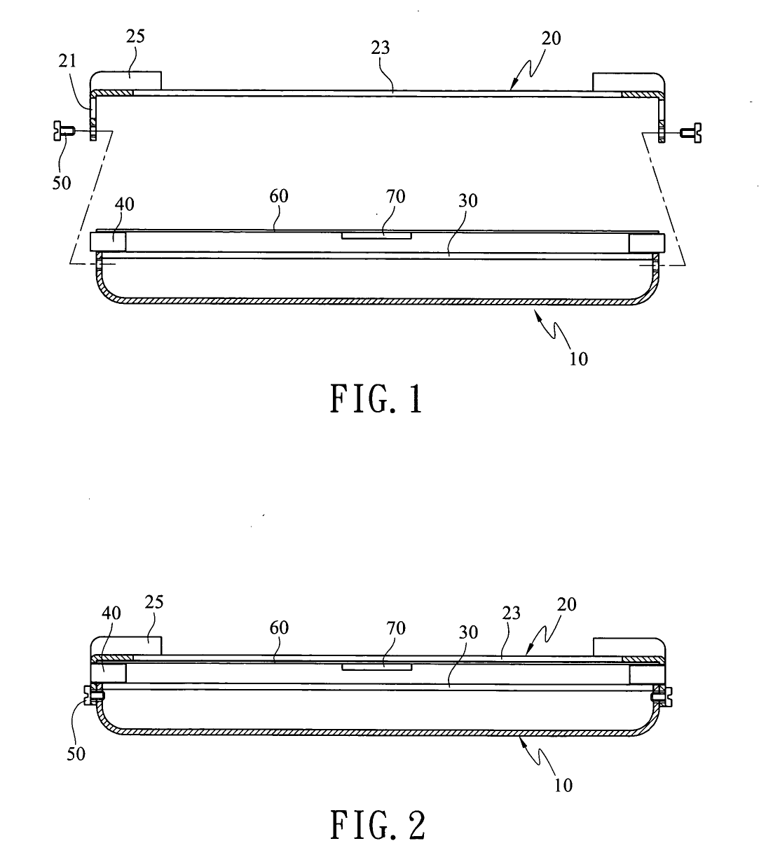

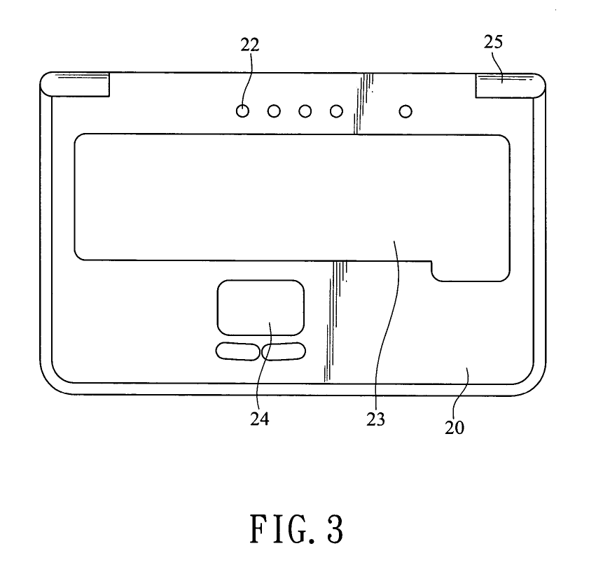

Referring to FIGS. 1, 2 and 3, the host structure for notebook computers according to the invention includes a bottom member 10 and a top member 20.

The bottom member 10 is substantially a case with an opening directly upwards to form a housing compartment to contain electronic elements such as a main board 30, central processor, memory, various connectors 40, hard disk drive, an optical disk drive, a radiation fan, battery, etc. (those elements without being marked with numbers are not shown in the drawings). The bottom member 10 is a standardized member. The electronic elements such as the hard disk drive, optical disk drive, battery and the like are fastened to selected locations in the bottom member. The bottom member 10 further has an electromagnetic isolation member 60 which has a touch panel 70 located thereon.

The top member 20 is substantially mating the bottom member 10 and covers the bottom member 10. The top member 20 has notches 21 formed on the sidewalls corresponding to where the connectors 40 are located. The top member 20 further has a plurality of round openings 22 of various sizes corresponding to indication lights (not shown in the drawings), and a pair of elongated troughs 23 corresponding to where the keyboard (not shown in the drawings) is mounted. There is also a plurality of rectangular troughs 24 corresponding to the touch panel 70. In addition, the top member 20 has a pivot seat 25 on one side to enable a LCD device (not shown in the drawings) to be coupled thereon in a turning manner.

The top member 20 can be coupled on the base member 10 by fastening a plurality of screwing elements 50 to become a notebook computer host. On the contrary, by unfastening the screwing elements 50, the top member 20 can be removed from the base member 10. During assembly or disassembly of the base member 10 and the top member 20, the electronic elements located in the base member 10 are not affected.

According to the host structure for notebook computers of the invention, the electronic elements in the base member 10 are assembled and fastened, thus the base member 10 becomes a standardized member. The style and shape of the top member 20 can be altered according to requirements as long as its coupling relationship with the base member 10 does not change. As the base member is not the main visual focus of the notebook computer, notebook computer vendors can merely alter the design of the top member 20 to get a new model or style. Thus the industrial design department does not have to coordinate and communicate with the electronic research for the new design. New types and models of machines can be developed in a much shorter time.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

1. A host structure for notebook computers, comprising:
a bottom member having a housing compartment for holding electronic elements; and
a top member for mating and covering the bottom member being coupled with the bottom member by fastening a plurality of screwing elements;
wherein the bottom member is a standardized member, the top member being formed with varying styles to couple with the bottom member to form a notebook computer host of a new style.

2. The host structure for notebook computers of claim 1, wherein the bottom member is a case having an opening directing upwards.

3. The host structure for notebook computers of claim 1, wherein the electronic elements include a main board, a central processor, a plurality of memories, a plurality of connectors, a hard disk drive, an optical disk drive, a radiation fan and a battery.

4. The host structure for notebook computers of claim 1, wherein the top member has a plurality of notches, a plurality of round openings, an elongated trough and a plurality of rectangular troughs corresponding to the electronic elements housed in the bottom member.

5. The host structure for notebook computers of claim 1, wherein the top member has a pivot seat located on one side thereof to allow a liquid crystal display device to be coupled thereon in a turnable manner.
